(19) United States
(12) Patent Application Publication
(10) Pub. No.: US 2013/0022244 A1
(43) Pub. Date: Jan. 24, 2013

(54) IMAGE PROCESSING APPARATUS AND IMAGE PROCESSING METHOD

(71) Applicants: Minehisa Nagata, Osaka (JP); Ryota Tsukidate, Osaka (JP)

(72) Inventors: Minehisa Nagata, Osaka (JP); Ryota Tsukidate, Osaka (JP)

(21) Appl. No.: 13/639,526

(22) PCT Filed: Feb. 21, 2012
(86) PCT No.: PCT/JP2012/001170

§ 371 Date: Oct. 5, 2012

(30) Foreign Application Priority Data
Feb. 24, 2011 (JP) 2011-038467

(51) Int. Cl. G06K 9/62

(52) U.S. Cl. 382/103

(57) ABSTRACT

An image processing apparatus comprises: an acquisition unit configured to acquire a plurality of image data items; an object detecting unit configured to detect a plurality of objects from the acquired image data items; a characteristic value calculation unit configured to calculate a characteristic value of each of the objects; a cluster information generating unit configured to, when the characteristic value of at least one of the objects meets a predetermined condition, generate first cluster information indicating a first cluster to which the at least one object belongs; a selecting unit configured to select an object for which a thumbnail is to be generated from among the at least one object indicated in the first cluster information; and a thumbnail generating unit configured to generate the thumbnail of the object using one of the image data items indicating the selected object.

### TECHNICAL FIELD

The present invention relates to an image processing apparatus and an image processing method for performing, on a plurality of objects shown in a plurality of images, processing for generating thumbnails.

### BACKGROUND ART

In recent years, applications for personal computers (PC) have been created which detect faces appearing in an image, display the detected faces in a list, and when one face is selected from the list, show the entire image in which the selected face appears.

However, general electronic devices differ from PCs in that the amount of memory used is relatively small and the CPUs used are relatively slow. Consequently, in addition to it taking time for these types of electronic devices to detect faces in images and create a list of the faces in real time, a problem arises in which a sufficient number of images cannot be shown due to insufficient memory.

A method can be devised in which the thumbnails for respective faces are generated in advance and displayed when the face list display is selected.

A conventional image processing apparatus which generates thumbnails of faces appearing in an image exists in which a person's face appearing in a displayed image is detected and a thumbnail for the face is generated (see Patent Literature (PTL) 1, for example).

FIG. 19 is a diagram showing a configuration of a conventional image processing apparatus disclosed in PTL 1.

In the conventional image processing apparatus 1000 shown in FIG. 19, a face detection unit 1603 detects a person's face from an image stored in a memory 1601, and notifies a CPU 1602 of the detection result. When a face is detected, the CPU 1602 instructs an image signal processing unit 1604 to generate a thumbnail for the face. The image signal processing unit 1604 crops out the region of the face from the image, and generates a thumbnail showing the facial region. When a plurality of faces are detected in a single image, the image signal processing unit 1604 generates a thumbnail for the face that is the closest to the center of the image, or generates thumbnails for all of the faces in the image.

### CITATION LIST

### Patent Literature

[PTL 1] Japanese Unexamined Patent Application Publication No. 2005-269563

### SUMMARY OF INVENTION

### Technical Problem

However, there is a problem with the above conventional configuration in which thumbnails are not generated for people who are important to the user when only a thumbnail is generated for the face which is closest to the center of the image. On the other hand, when thumbnails are generated for every face in the image, thumbnails are generated for faces which are not important to the user, such as the face of a passerby in the background. As a result, a problem arises in which recording medium space is wastefully used.

The object of the present invention which solves the foregoing problems is to provide an image processing apparatus which efficiently processes the generation of thumbnails of a plurality of objects acquired from a plurality of images, and an image processing method for the same.

### Solution to Problem

In order to solve the above-mentioned problems, the image processing apparatus according to present invention includes: an acquisition unit configured to acquire a plurality of image data items; an object detecting unit configured to detect a plurality of objects from the image data items acquired by the acquisition unit, each of the objects being indicated in at least one of the image data items; a characteristic value calculation unit configured to calculate a characteristic value of each of the objects detected by the object detecting unit; a cluster information generating unit configured to, when the characteristic value of at least one of the objects meets a predetermined condition, generate first cluster information indicating a first cluster which is associated with the characteristic value of the at least one object and to which the at least one object belongs; a selecting unit configured to select an object for which a thumbnail is to be generated from among the at least one object indicated in the first cluster information generated by the cluster information generating unit; and a thumbnail generating unit configured to generate the thumbnail of the object using one of the image data items that indicates the object selected by the selecting unit.

With this, when the characteristic value of an object from a plurality of objects meets a predetermined condition, first cluster information indicating a first cluster to which the object belongs is generated. That is, a first cluster to which the object meeting the predetermined condition belongs is generated.

Furthermore, at least one object belonging to the first cluster is selected, and a thumbnail of the at least one object selected is generated.

That is, the characteristic value of each object is checked, and only the objects which meet the predetermined condition are registered in the cluster. Only objects registered in the cluster are eligible as candidates for thumbnail generation. In other words, objects which do not meet the predetermined condition are not eligible as candidates for thumbnail generation.

Therefore, according to this aspect of the image processing apparatus, it is possible to generate thumbnails only for objects which are thought to be of importance to a user, for example, and as a result, it is possible to achieve high-speed display of a list of thumbnails, for example.

Furthermore, according to this aspect of the image processing apparatus, it is possible to exclude objects as candidates for thumbnail generation which are not thought to be of importance, for example, and as a result, it is possible to limit nonessential processes and the wasteful use of recording medium space.

In this way, according to this aspect of the image processing apparatus, it is possible to efficiently process the generation of thumbnails for a plurality of objects acquired from a plurality of images.

Moreover, in the image processing apparatus according to an aspect of the present invention, when the characteristic value of each of two or more of the objects including the at least one object meets the predetermined condition, the cluster information generating unit may be configured to generate the first cluster information indicating the first cluster to which the two or more objects belong, the predetermined condition being that the characteristic value of each of the two or more objects is within a predetermined range.

With this, when the characteristic values of two or more objects are within a predetermined range, first cluster information indicating the first cluster to which these objects belong is generated. That is, when a plurality of objects are similar, first cluster information which associates the plurality of objects with the first cluster is generated.

Accordingly, when a plurality of image data items are acquired as a result of one or more being photographed, it is possible to generate thumbnails for only objects which appear in common in a predetermined number of two or more image data items. As a result, thumbnails are only generated for objects which are thought to be of importance to the user, for example.

Moreover, in the image processing apparatus according to an aspect of the present invention, when an input of an integer N greater than or equal to two is received and N objects including the at least one object each has a characteristic value calculated by the characteristic value calculation unit that is within the predetermined range, the cluster information generating unit may be configured to generate the first cluster information indicating the first cluster to which the N objects belong.

With this, as a condition for the generation of the cluster information, the N objects having characteristic values which are closely related is treated as a variable number. For this reason, by increasing the value of N when multiple image data items are candidates for processing, a condition for the selection of objects as candidates for thumbnail generation can be made stricter, for example.

Moreover, in the image processing apparatus according to an aspect of the present invention, when the characteristic value of the at least one object meets the predetermined condition, the cluster information generating unit may be configured to generate the first cluster information indicating the first cluster to which the at least one object belongs, the predetermined condition being that the characteristic value exceeds a threshold value.

With this, even when an object is only indicated in one image data item, if the ratio of the area of the object to the entire image size is greater than a threshold value, for example, first cluster information indicating that the object belongs to the first cluster is generated.

For example, even when there is only one image data item which indicates a given object, if the image data item is obtained as a result of the object being photographed up close, the object is not excluded as a candidate for thumbnail generation, and first cluster information including information identifying the object is generated.

Moreover, in the image processing apparatus according to an aspect of the present invention, when a characteristic value calculated by the characteristic value calculation unit of one of the objects other than the at least one object meets the predetermined condition, the cluster information generating unit may be configured to update the generated first cluster information to include the other object in the first cluster.

With this, when the characteristic value of a newly detected object falls within the range of an already existing characteristic value which corresponds with the first cluster, for example, the newly detected object is added to the first cluster.

For example, consider that image data resulting from a specific person or a specific physical object other than a person being photographed is registered in the first cluster. In this case, the acquired image data indicating the person or the physical object is registered in the first cluster, thereby becoming eligible as a candidate for thumbnail generation.

Moreover, in the image processing apparatus according to an aspect of the present invention, the selecting unit may be configured to select all of the objects indicated in the first cluster information as objects for which thumbnails are to be generated, and the thumbnail generating unit may be configured to generate thumbnails of all the objects selected by the selecting unit, using the respective image data items indicating all the objects.

With this, thumbnails are generated for each object belonging to the first cluster, for example. As a result, the user can confirm whether the objects corresponding to the thumbnails should belong in the first cluster or not on an individual basis, for example.

Moreover, in the image processing apparatus according to an aspect of the present invention, when a characteristic value calculated by the characteristic value calculation unit of one of the objects other than the at least one object (i) does not meet the predetermined condition and (ii) the characteristic value of the other object and the characteristic value of a preexisting one of the objects which does not meet the predetermined condition are within a predetermined range, the cluster information generating unit may be further configured to generate second cluster information indicating a second cluster to which the other object and the preexisting object belong, and the selecting unit may be further configured to select, from at least one of the first cluster information and the second cluster information, an object for which a thumbnail is to be generated.

With this, it is determined that the newly detected object does not belong to a previously existing cluster (the first cluster) since the characteristic value of the object does not meet the predetermined condition. Additionally, when the characteristic value of the object meets another condition, second cluster information associated with the object is generated.

In other words, a plurality of cluster information corresponding to the clustering result of a plurality of objects is generated. For this reason, for example, when a number of image data items are acquired which include a group of a plurality of members, a cluster is generated for each member, and only objects belonging to these clusters (that is, images showing the faces of the members) are treated as candidates for thumbnail generation.

Moreover, in the image processing apparatus according to an aspect of the present invention, the selecting unit may be further configured to select, from among each of the first cluster information and the second cluster information, an object for which a thumbnail is to be generated.

With this, at least one object is selected from a plurality of clusters, and a thumbnail is generated for the selected object. For example, when a plurality of objects are classified into a plurality of clusters, a list showing these clusters can be displayed in which the thumbnails corresponding to the clusters are shown.

Moreover, in the image processing apparatus according to an aspect of the present invention, the selecting unit may be configured to select, from among the three or more of the objects indicated in the first cluster information and including the at least one object, an object for which a thumbnail is to be generated having the characteristic value that is closest to an average value of characteristic values of the three or more objects.

With this, from among a plurality of objects included in a single cluster, an object having a characteristic value that is close to the cluster average is selected as a candidate for thumbnail generation. In other words, an object considered to be a representative object of the cluster is selected, and a thumbnail for that object is generated.

For this reason, for example, a list showing these clusters can be displayed in which thumbnails which clearly represent their clusters are shown by performing the above processing for each cluster.

Moreover, in the image processing apparatus according to an aspect of the present invention, the selecting unit may be further configured to select, from among three or more of the objects indicated in the first cluster information and including the at least one object, an object for which a thumbnail is to be generated having the characteristic value that is different from the average value of characteristic values of the three or more objects by a value that is greater than or equal to a predetermined value or a value that is greatest.

With this, from among a plurality of objects included in a single cluster, an object having a characteristic value that is far off from the cluster average is selected, and a thumbnail for the selected object is generated.

For this reason, for example, a thumbnail is generated for an object which, in essence, should not be in the cluster. As a result, the user can delete the object from the cluster relatively early on as well as delete the generated thumbnail relatively early on. In other words, correction of an erroneous cluster generation is made at a relatively early stage, and wasteful use of space on the recording medium can be reduced.

Moreover, in the image processing apparatus according to an aspect of the present invention, the thumbnail generating unit may be configured to (i) record the generated thumbnail on a recording medium connected to the image processing apparatus, and (ii) when the generated thumbnail is deleted from the recording medium as per a predetermined instruction made by a user, delete an other thumbnail stored on the recording medium corresponding to one of the objects having the characteristic value that is different from the characteristic value of the deleted thumbnail by a value that is less than a predetermined value.

With this, for example, when a thumbnail deemed unnecessary by a user is deleted, other thumbnails also estimated to be similarly unnecessary are deleted. This makes it possible to use space on the recording medium on which the plurality of thumbnails are stored even more effectively.

Moreover, in the image processing apparatus according to an aspect of the present invention, when the thumbnail deleted from the recording medium is to be generated once again, the thumbnail generating unit may be further configured to once again generate the other thumbnail deleted along with the thumbnail.

With this, for example, previously deleted thumbnails can be restored in a singly batch when they become needed.

Moreover, in the image processing apparatus according to an aspect of the present invention, each of the objects may be, in whole or in part, a face of a person or a physical object other than a person.

With this, for example, rapid display of the thumbnail list can be realized by generating thumbnails for faces or physical objects believed to be of importance to a user. Moreover, wasteful use of space on the recording medium can be reduced by not generating thumbnails for faces or physical objects not believed to be of importance to a user.

The present invention can moreover be realized as an image processing method including a characteristic process executed by the image processing apparatus according to any one of the preceding aspects.

The present invention can moreover be realized as a computer program for causing a computer to perform processes included in the image processing method or as a recording medium having the computer program thereon. The program can then be distributed via a transmission medium such as the Internet or a recording medium such as a DVD.

The present invention can moreover be realized as an integrated circuit having a characteristic component included in the image processing apparatus according to any of the preceding aspects.

### Advantageous Effects of Invention

With the image processing apparatus and the image processing method according to the present invention, it is possible to achieve high-speed display of a list of thumbnails and reduce wasteful use of recording medium space by generating thumbnails for objects which are believed to be of importance to the user, and by not generating thumbnails for objects which are not believed to be of importance to the user.

That is, the present invention provides an image processing apparatus which efficiently processes the generation of thumbnails of a plurality of objects acquired from a plurality of images, and provides an image processing method for the same.

### BRIEF DESCRIPTION OF DRAWINGS

FIG. 1 is a block diagram showing the main function of the configuration of the image processing apparatus according to an embodiment of the present invention.

FIG. 2 is a diagrammatic view showing a first example of an image which is a candidate for processing according to an embodiment of the present invention.

FIG. 3 is a diagrammatic view showing a second example of an image which is a candidate for processing according to an embodiment of the present invention.

FIG. 4 is a diagrammatic view showing a third example of an image which is a candidate for processing according to an embodiment of the present invention.

FIG. 5 is a diagrammatic view showing a fourth example of an image which is a candidate for processing according to an embodiment of the present invention.

FIG. 6 is a diagrammatic view showing a fifth example of an image which is a candidate for processing according to an embodiment of the present invention.

FIG. 7 is an example of a data structure of the detection result database according to an embodiment of the present invention.

FIG. 8 is an example of a data structure of the cluster information database according to an embodiment of the present invention.

FIG. 9 is a flow chart outlining the flow of processes executed by the image processing apparatus according to an embodiment of the present invention.

FIG. 10 is a flow chart showing details of the classification processes executed by the image processing apparatus according to an embodiment of the present invention.

FIG. 11 is a flow chart showing details of the cluster generation or updating processes executed by the image processing apparatus according to an embodiment of the present invention.

FIG. 12 is a flow chart showing details of the thumbnail generation processes executed by the image processing apparatus according to an embodiment of the present invention.

FIG. 13 is an example of a data structure of the image management database stored in S506 shown in FIG. 12 according to an embodiment of the present invention.

FIG. 14 is an example of a data structure of the face thumbnail database stored in S505 shown in FIG. 12 according to an embodiment of the present invention.

FIG. 15 is another example of a data structure of the cluster information database according to an embodiment of the present invention.

FIG. 16 is a flow chart outlining the cluster generation processes when an N number is made to be a variable number as a cluster information generation condition.

FIG. 17 is a flow chart outlining the cluster generation processes associated with the comparison of a threshold value and the characteristic value of an object which is a candidate for processing.

FIG. 18A is an example of a cluster list output from the image processing apparatus according to an aspect of the present invention.

FIG. 18B is an example of a thumbnail list output from the image processing apparatus according to an aspect of the present invention.

FIG. 18C is an example showing a manner in which a selected image is displayed as output from the image processing apparatus according to an aspect of the present invention.

FIG. 18D is another example showing a manner in which a selected image is displayed as output from the image processing apparatus according to an aspect of the present invention.

FIG. 19 is a diagram showing a configuration of a conventional image processing apparatus.

### DESCRIPTION OF EMBODIMENTS

Hereinafter, an embodiment of present invention is described with reference to the drawings. It is to be noted that the embodiment described hereinafter is a preferred specific example of the present invention. The numerical values, shapes, materials, structural elements, the arrangement and connection of the structural elements, steps, the processing order of the steps etc. shown in the following exemplary embodiments are mere examples, and therefore do not limit the present invention. Moreover, among the structural elements in the following exemplary embodiments, structural elements not recited in any one of the independent claims disclosing the most significant part of the inventive concept are described as arbitrary structural elements.

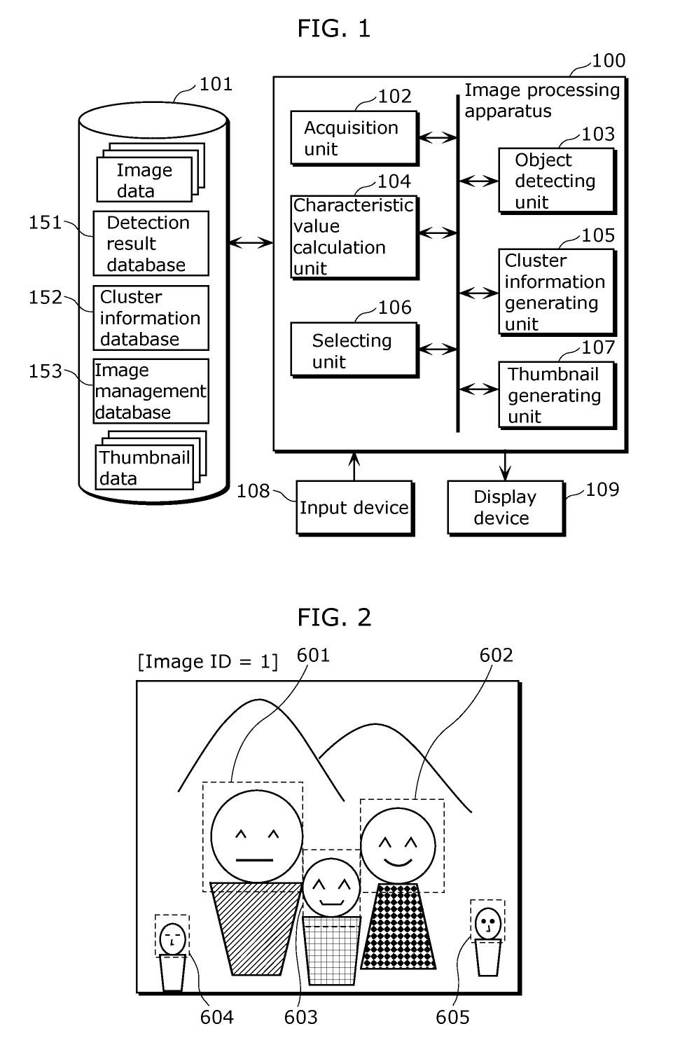

FIG. 1 is a block diagram showing the main functional configuration of an image processing apparatus 100 according to an embodiment of the present invention.

The image processing apparatus 100 includes an acquisition unit 102, a object detecting unit 103, a characteristic value calculation unit 104, a cluster information generating unit 105, a selecting unit 106, and a thumbnail generating unit 107.

Moreover, a recording medium 101, an input device 108, and a display device 109 are connected together in the image processing apparatus 100. The configurations of the respective components will be explained below.

The recording medium 101 is a medium for storing various information including the image data, and is connected to the image processing apparatus 100 via a wired or wireless connection. According to this embodiment, in addition to image data and thumbnail data, a detection result database 151, a cluster information database 152, and an image management database 153 are stored on the recording medium 101. It is to be noted that each of these types of information may be stored on separate recording media.

The acquisition unit 102 acquires the image data from the recording medium 101. Moreover, the acquisition unit 102 may acquire the image data from a different device that it is connected to over a communications network, for example.

The object detecting unit 103 detects an object shown in the image data. According to this embodiment, facial regions of people shown in image data items are detected. The object detecting unit 103 can store the detected facial region information in, for example, the detection result database 151 on the recording medium 101.

It is to be noted that a representative method of facial detection includes the facial detection method invented by P. Viola and M. Jones known as robust real time object detection. However, since the essence of the present invention does not relate to facial detection methods, details thereof will be omitted.

The characteristic value calculation unit 104 calculates characteristic values for facial regions detected by the object detecting unit 103. Representative methods of characteristic value calculation include Speeded Up Robust Features (SURF) and Scale-Invariant Feature Transform (SIFT). However, since the essence of the present invention does not relate to characteristic value calculation methods, details thereof will be omitted.

When the characteristic value of at least one of the objects from the plurality of objects meets a predetermined condition, the cluster information generating unit 105 generates cluster information indicating a first cluster which is associated with the characteristic value of the at least one object and to which the at least one object belongs.

According to this embodiment, the cluster information generating unit 105 compares two or more facial region characteristic values calculated by the characteristic value calculation unit 104, and registers to the same cluster two or more facial regions determined to have characteristic values which are similar. In other words, cluster information in which the two or more facial regions and the cluster are associated is generated and stored in the cluster information database 152 on the recording medium 101.

That is, when each of the characteristic values corresponding to the two or more objects is within a predetermined range, cluster information which indicates the cluster to which the two or more objects belong is generated and stored.

However, facial regions determined to have characteristic values which are not similar are not registered to a preexisting cluster, and at that point in time new cluster information is not generated nor stored in the cluster information database 152.

The selecting unit 106 checks the cluster information database 152 and selects at least one facial region which is registered in at least one cluster. According to this embodiment, all facial regions registered in a cluster are selected.

The thumbnail generating unit 107 crops out facial regions from the respective image data for each of the facial regions selected, and generates face thumbnail data (hereinafter simply referred to as face thumbnail) of a predetermined size (for example 120 pixels wide by 120 pixels tall). Next, the thumbnail generating unit 107 stores the generated face thumbnails on the recording medium 101.

It is to be noted that the size of the face thumbnail does not need to be 120 pixels wide by 120 pixels tall, but may be larger. Moreover, the width and height of the face thumbnail do not need to be the same.

The input device 108 receives and outputs to the image processing apparatus 100 user action information and input text with respect to the image processing apparatus 100.

The display device 109 displays image data and face thumbnails, for example, that are stored on the recording medium 101. Moreover, the display device 109 switches between the display of image data and face thumbnails based on a user operation as received by the input device 108.

FIG. 2 through FIG. 6 are each diagrammatic views showing an example of an image indicated in image data which is a candidate for processing by the image processing apparatus 100. Moreover, in each of the Drawings, the rectangles indicated by dashed lines are added to the image for ease of explanation, and are not part of the images themselves.

The image in FIG. 2 is an image having an image ID of 1, and each of the regions encompassed by the rectangles 601 through 605 are facial regions detected by the object detecting unit 103.

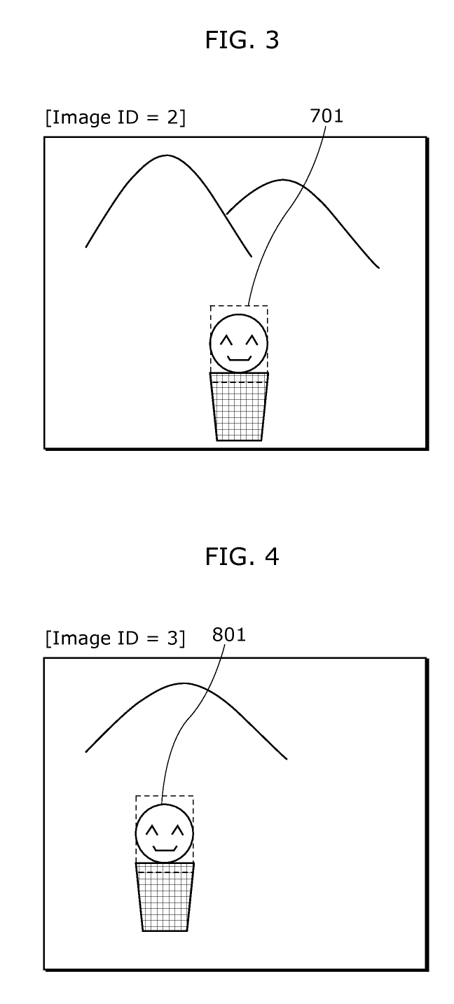

Moreover, the image in FIG. 3 is an image having an image ID of 2, and the region encompassed by the rectangle 701 is a facial region detected by the object detecting unit 103.

Moreover, the image in FIG. 4 is an image having an image ID of 3, and the region encompassed by the rectangle 801 is a facial region detected by the object detecting unit 103.

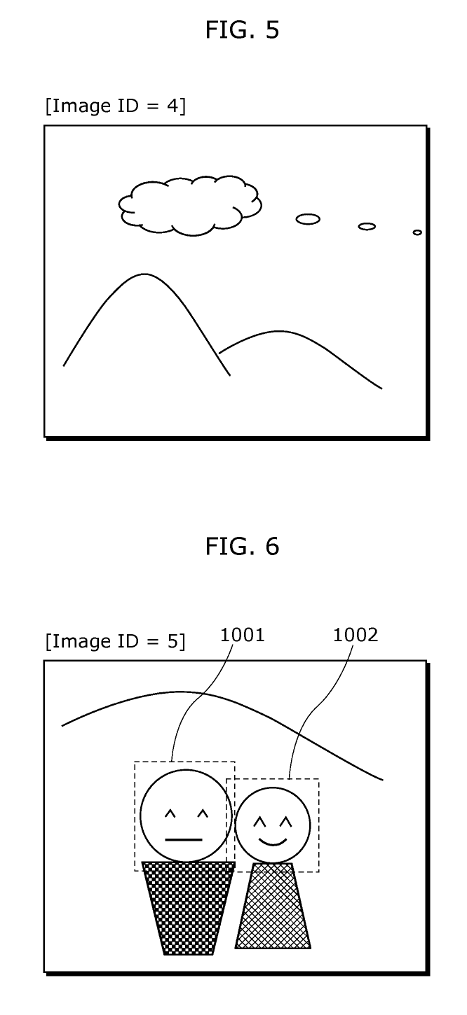

Moreover, the image in FIG. 5 is an image having an image ID of 4 in which no facial region has been detected by the object detecting unit 103.

Moreover, the image in FIG. 6 is an image having an image ID of 5, and the regions encompassed by the rectangles 1001 and 1002 are facial regions detected by the object detecting unit 103.

In this way, the information for each of the facial regions detected by the object detecting unit 103 is stored in the detection result database 151.

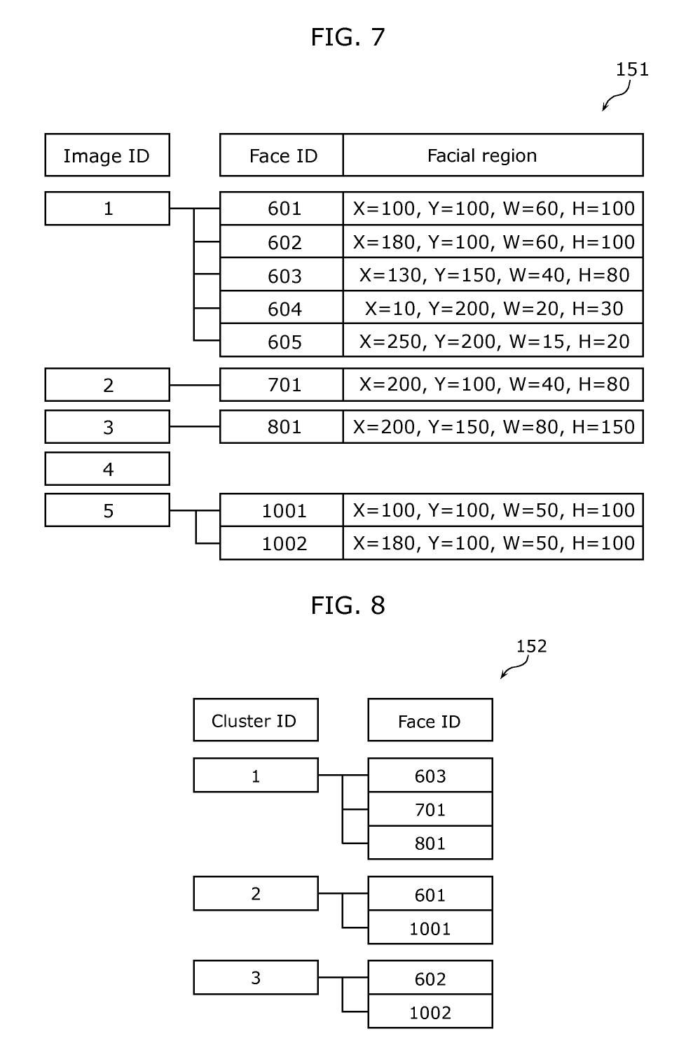

FIG. 7 is an example of a data structure of the detection result database 151 according to this embodiment.

As shown in FIG. 7, image IDs for identifying the image data for each of the image IDs of 1 to 5, face IDs for identifying the facial region included in the image data, and facial region information are stored in the detection result database 151.

According to this embodiment, facial region information is displayed as X and Y coordinates in the image (X and Y in the Drawings), and as a width (W in the Drawings) and height (H in the Drawings). However, the facial regions may be specified with information other than this information. It is to be noted that in the explanations, the face ID numbers and the facial region numbers match. For example, the face ID 601 represents the rectangle 601.

FIG. 8 is an example of a data structure of the cluster information database 152 according to this embodiment.

Specifically, based on each facial region characteristic value, the cluster information generating unit 105 generates each piece of cluster information such that facial regions having similar characteristic values are added to the same cluster. The cluster information database 152 is constituted by the cluster information generated in this manner.

In other words, according to this embodiment, face IDs of facial regions having similar characteristic values are stored in the same cluster in the cluster information database 152.

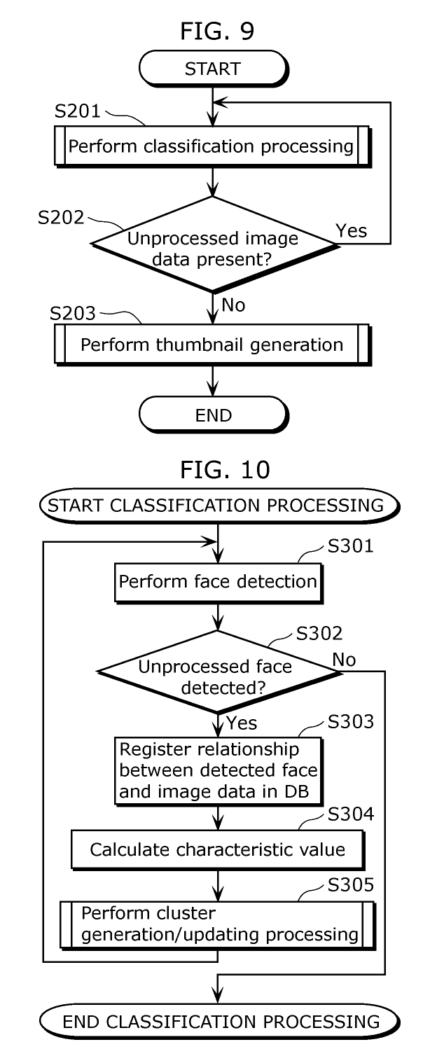

Operation of the image processing apparatus 100 configured as described will be explained while referring to the flowcharts shown in FIG. 9 to FIG. 12.

FIG. 9 is a flow chart outlining the flow of processes executed by the image processing apparatus 100 according to this embodiment.

First, the image processing apparatus 100 acquires image data stored in the recording medium 101 and classifies the image data (S201). The classification processing will be described later.

Next, if there are still image data items which have not been classified (yes in S202), the image processing apparatus 100 returns to S201 to classify those image data items. If there are no image data items which have not been classified (no in S202), the image processing apparatus 100 proceeds to S203.

Next, the image processing apparatus 100 performs the process of generating the thumbnails (explained later) (S203), and the processing is completed.

(Classification Processing)

FIG. 10 is a flow chart showing details of the classification processes executed by the image processing apparatus 100 according to this embodiment.

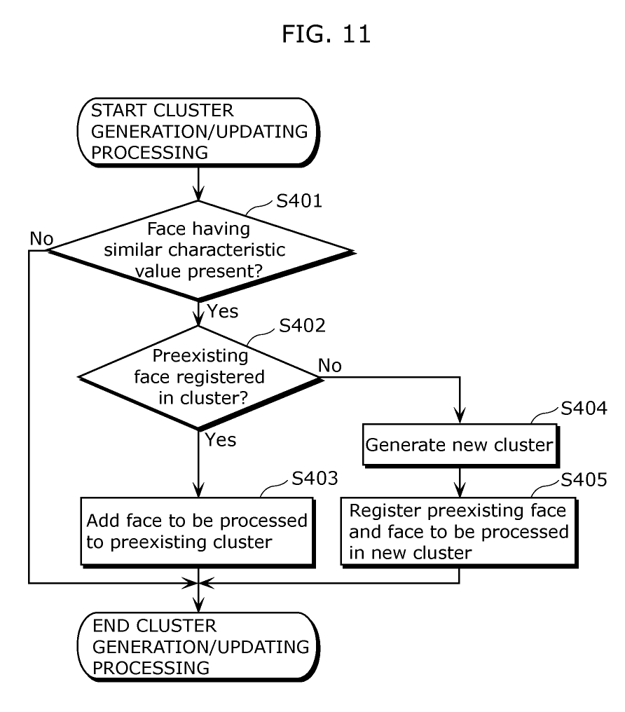

FIG. 11 is a flow chart showing details of the cluster information generation or updating processes executed by the image processing apparatus 100 according to this embodiment.

The processes in S201 (classification processing) in FIG. 9 will be explained using the flowcharts shown in FIG. 10 and FIG. 11.

In the classification processing, the object detecting unit 103 starts the processing for detecting the faces of people shown in the image data item (S301).

Next, when faces are detected which have not yet been detected (unprocessed faces) (yes in S302), the image processing apparatus 100 proceeds to S303. In S301, when unprocessed faces are not detected (no in S302), the classification process is ended for that image data item.

Next, the object detecting unit 103 stores the detected facial region information for each image data item in the detection result database 151 (see FIG. 7) (S303).

Next, the characteristic value calculation unit 104 calculates and stores the characteristic value for each of the detected facial regions (S304). It is to be noted that each calculated characteristic value may be stored in association with the face ID in the detection result database 151 or the cluster information database 152, for example.

Moreover, the characteristic values for the facial regions may be, for example, physical quantities such as a silhouette of a face included in a facial region, a measure of edge strength along the silhouette, a location of the eyes and nose on the face, or a ratio of the area of the facial region to the area of the entire image which includes the facial region, or any combination of these physical quantities.

Next, based on the calculated characteristic values, the cluster information generating unit 105 executes the cluster generation or updating processing (S305).

When the cluster generation or updating processing (S305) is complete, the image processing apparatus 100 returns to S301.

(Cluster Generation or Updating Processing)

In the cluster generation or updating processing, the cluster information generating unit 105 compares a characteristic value calculated in S304 in FIG. 10 for a facial region that is a current candidate for processing (current facial region) with a previously calculated characteristic value for a facial region (previous facial region). As a result, the cluster information generating unit 105 determines whether or not there is a previous facial region having a characteristic value that is similar to the characteristic value for the current facial region.

For example, the cluster information generating unit 105 determines that there is a previous facial region having a characteristic value that is similar to the characteristic value for the current facial region when the characteristic value for the current facial region and the characteristic value for the previous facial region are within a predetermined range (that is, when the difference between the two characteristic values is smaller than a predetermined value).

For example, when the characteristic value for each facial region is expressed as a physical value m, the characteristic value for each facial region is expressed as coordinates in a characteristic value space in the dimension m. Moreover, when the distance between coordinates for a characteristic value a for a facial region A and coordinates for a characteristic value b for a facial region B is shorter than a predetermined value, the facial region A and the facial region B are determined to be approximate (the characteristic value a and the characteristic value b are determined to be similar).

Moreover, consider that the difference between the average value of the characteristic values for the plurality of previous facial regions belonging to a previously generated cluster and the characteristic value for the current facial region is less than a predetermined value. In this case, the characteristic values for each of the two or more facial regions included in the current facial region can be expressed as being within the predetermined range. In other words, it can be determined that there is a previous facial region having a characteristic value that is similar to the characteristic value for the current facial region.

If a previous facial region having a similar characteristic value is present (yes in S401), the image processing apparatus 100 proceeds to S402. If a previous facial region having a similar characteristic value is not present (no in S401), the cluster generation or updating processing for the current facial region is completed.

Next, the cluster information generating unit 105 confirms whether or not the previous facial region having the characteristic value that was determined in S401 to be similar to the characteristic value for the current facial region is already registered in a cluster or not (S402). If already registered in a cluster (yes in S402), the image processing apparatus 100 proceeds to S403. If not already registered (no in S402), the image processing apparatus 100 proceeds to S404.

When the result of the confirmation in S402 is that the previous facial region is registered in a cluster (yes in S402), the cluster information generating unit 105 adds the current facial region to that cluster. That is, the cluster information generating unit 105 updates the cluster information for that cluster to include the current facial region (S403). After updating, the cluster generation or updating processing is completed.

When the result of the confirmation in S402 is that the previous facial region is not registered in a cluster, a new cluster is generated (S404).

The previous facial region in question and the current facial region are then registered in the new cluster (S405). That is, the cluster information generating unit 105 generates cluster information indicating that the previous facial region in question and the current facial region belong to the new cluster. After generating the cluster information, the cluster generation or updating processing is completed.

As a result of the confirmation processing and the cluster generation or updating processing described above, two or more facial regions having similar characteristic values are registered in a single cluster. Consequently, more than one cluster to which a plurality of facial regions belong exists.

In other words, according to this embodiment, when, from among a plurality of facial regions shown in one or more image data items that are candidates for processing, at least two facial regions exist which each have a characteristic value that meets a predetermined condition, a cluster is generated which includes those facial regions. Specifically, cluster information is generated in which the two facial regions are associated with the cluster.

Even more specifically, when (i) the characteristic value for the current facial region is not within the range of a characteristic value corresponding to an already existing cluster and (ii) the characteristic value for the current facial region and the characteristic value for the previous facial region are both within a predetermined range, the cluster information generating unit 105 generates cluster information which indicates a new cluster to which the characteristic value for the current facial region and the characteristic value for the previous facial region belong.

Moreover, when the characteristic value for the current facial region is within the range of a characteristic value corresponding to an already existing cluster, the already generated cluster information is updated to include the current facial region in the cluster.

In this way, as a result of the classification processing and the cluster generation and updating processes being performed on each object, cluster information such as is shown in FIG. 8 is stored in the cluster information database 152 by the cluster information generating unit 105.

Specifically, FIG. 8 shows the data structure of the cluster information database 152 as a result of the classification processing and the cluster generation and updating processing being performed on the images with the image IDs of 1 through 5 shown in FIG. 2 through FIG. 6.

As shown in FIG. 8, the characteristic values for the facial regions represented by the face IDs 603, 701, and 801 have been determined to be similar, and as a result those face IDs have been registered in the cluster with an ID of 1. Moreover, the characteristic values for the facial regions represented by the face IDs 601 and 1001 have been determined to be similar, and as a result those face IDs have been registered in the cluster with an ID of 2. Furthermore, the characteristic values for the facial regions represented by the face IDs 602 and 1002 have been determined to be similar, and as a result those face IDs have been registered in the cluster with an ID of 3.

In this way, from among the plurality of objects obtained from the plurality of image data items, only those objects having characteristic values which have met a predetermined condition are registered in a cluster. According to this embodiment, two or more of only the facial regions having similar characteristic values (that is, characteristic values which are within a predetermined range) are registered in a cluster.

Each facial region registered in any one of the clusters is eligible as a candidate for thumbnail generation. According to this embodiment, thumbnails are generated for every facial region belonging to any one of the clusters.

(Thumbnail Generation Processes)

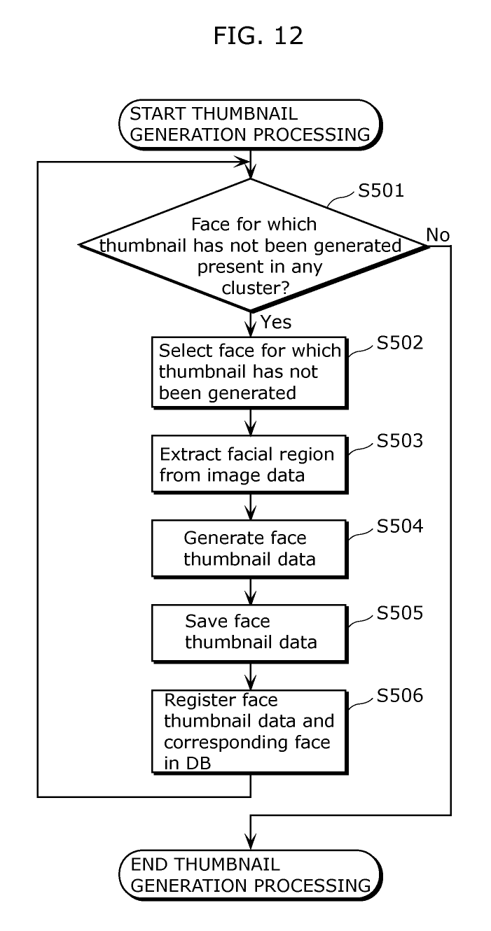

FIG. 12 is a flow chart showing details of the thumbnail generation processes executed by the image processing apparatus 100 according to this embodiment.

The processes in S203 (thumbnail generation processes) in FIG. 9 will be explained using the flowchart shown in FIG. 12.

First, the selecting unit 106 checks the cluster information database 152 to confirm whether or not there are any facial regions registered in any one of the clusters for which a face thumbnail has not yet been generated. If a facial region for which a face thumbnail has not yet been generated is found (yes in S501), the image processing apparatus 100 proceeds to S502. If not found (no in S501), the image processing apparatus 100 ends the thumbnail generation processing.

The selecting unit 106 then selects one of the facial regions for which a face thumbnail has not yet been generated, as determined in S501 (S502).

Next, the thumbnail generating unit 107 crops out the facial region from the image data depicting the facial region selected in S502 (S503).

The thumbnail generating unit 107 then generates a face thumbnail of a predetermined size (for example, 120 pixels wide by 120 pixels tall) by transforming the image in some manner such as increasing or decreasing the size of the cropped facial region (S504).

Next, the thumbnail generating unit 107 stores the face thumbnail generated in S504 in the recording medium 101 (S505).

The thumbnail generating unit 107 then stores, in the image management database 153 in the recording medium 101, the association of the facial region and the face thumbnail stored in S505. Afterwards, the image processing apparatus 100 returns to S501.

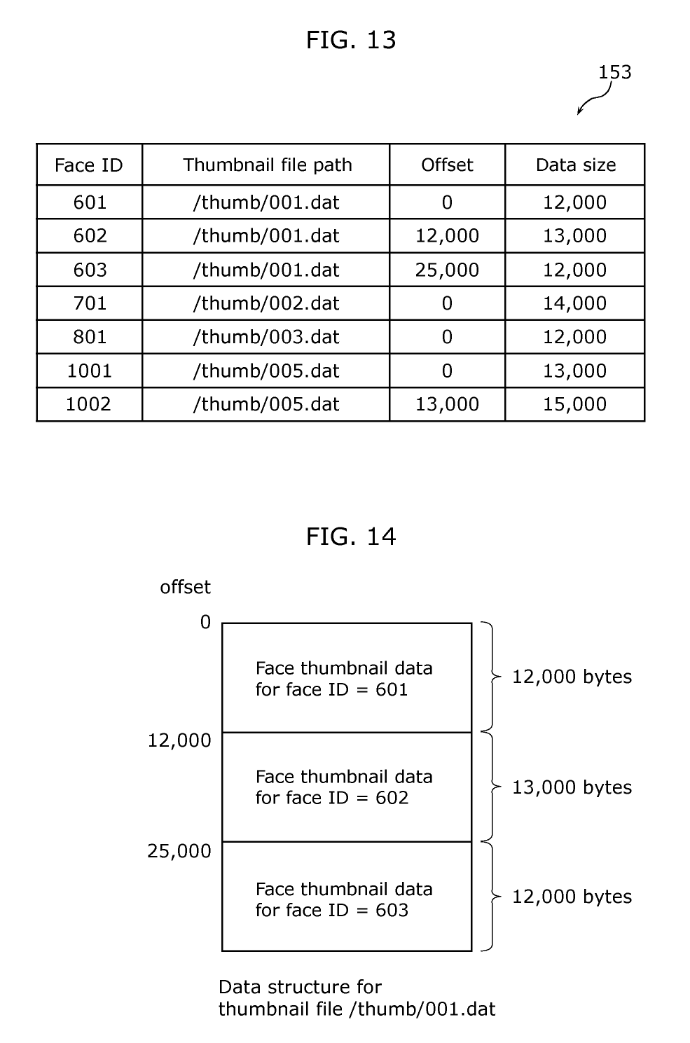

FIG. 13 is an example of a data structure of the image management database 153 stored in S506 shown in FIG. 12.

FIG. 14 is an example of a data structure of the face thumbnail database stored in S505 shown in FIG. 12.

As shown in FIG. 13, image management database 153 includes face IDs which represent the facial regions for which face thumbnails have been generated. Associated with each of the face IDs is file path information for the recording medium 101 pointing to the thumbnail file including face thumbnail data, the offset within the thumbnail file, and the data size of the of the thumbnail file.

According to this embodiment, face thumbnail data for each of the plurality of facial regions within a single image data item are stored in a single file.

FIG. 14 is an example of a data structure of the thumbnail files according to an embodiment.

Specifically, FIG. 14 shows a thumbnail file for three facial regions included in the image data for the image with an ID of 1. Each piece of face thumbnail data is organized in order of generation from the head of the thumbnail file.

Upon display of a face thumbnail on the display device 109, the display control unit (not shown in the Drawings) included in the image processing apparatus 100 checks a save location of the face thumbnail data from the image management database 153 shown in FIG. 13, for example. Furthermore, the display control unit retrieves the face thumbnail data from the thumbnail file shown in FIG. 14 and displays it on the display device 109.

According to this embodiment, the facial regions represented by the face IDs 604 and 605 in the image data for the image with an ID of 1 are not registered in a cluster, and face thumbnail data is not generated.

Checking the five images that are candidates for processing according to this embodiment reveals that the people corresponding to the face IDs 604 and 605 only appear in one image (image ID 1). It is therefore highly possible that these people are, for example, passersby photographed in the background. That is, it is possible that these people shown in the facial regions having the face IDs of 604 and 605 are not of importance to the user.

In this way, the image processing apparatus 100 according to this embodiment does not generate face thumbnails for facial regions which may not be of importance to the user. In other words, the image processing apparatus 100 can limit the execution of nonessential image processing as well as limit wasteful use of storage space on the recording medium 101.

On the other hand, for a facial region that is registered in a cluster, the image processing apparatus 100 can confirm that at least one other facial region which exists is similar to the facial region. That is, it is inferred that a plurality of facial regions which belong to the same cluster are regions of pictures which depict the same person. Additionally, it is highly likely that the person is of importance to the user due to the fact that the person appears in a plurality of images (is indicated in a plurality of image data items).

The image processing apparatus 100 according to this embodiment is capable of generating face thumbnails for people which are highly likely to be of importance to the user in advance. As a result, the face thumbnails which have been generated in advance can be shown upon display of the plurality of face thumbnails based on the plurality of image data items. Thus, even when the image processing apparatus 100 is realized as an electronics device with low processing performance, the display speed is improved.

Moreover, each face thumbnail is classified per cluster. For that reason, when, for example, one face thumbnail from among the plurality of face thumbnails included in a cluster is selected as a representative image for the cluster and a list of the clusters is displayed, it is possible to display the representative image face thumbnails for each cluster in the list.

As a result, it is possible to assign a person's name on a cluster-by-cluster basis, for example. This makes it possible to reduce the burden of assigning names to a plurality of image data items one by one for the user.

It is to be noted that in this embodiment the facial region information is expressed as X and y coordinates and width and height, which represent a dashed line rectangle. However, other methods may be used as a method of expressing facial regions, such as coordinates or a radii representing a circle or an ellipse.

Moreover, methods using coordinates of vertexes or central coordinates and vectors to vertexes from central coordinates representing, for example, polygons, or as vectors from a base point may be used to express facial regions.

In other words, any method can be used to express a facial region as long as the method represents a specified region on the image.

With this, for example, the facial region can be specified using a more defined border line. It is to be noted that units of pixels or units of length such as millimeters may be used for the coordinates.

Moreover, the recording medium 101 may be connected to the image processing apparatus 100 according to this embodiment externally via an interface including via a wired or wireless connection. The recording medium 101 may be connected to the image processing apparatus 100 via a communications network such as the Internet. Furthermore, it is possible for a plurality of recording media to be connected to the image processing apparatus 100 This allows for a flexible system configuration.

For example, consider a case in which the image processing apparatus 100 is included in a server apparatus connected to the Internet. Here, a plurality of image data items stored in the recording medium 101 are transmitted from a portable terminal which includes the recording medium 101 to the server apparatus. Accordingly, the server apparatus can be caused to execute the cluster information processing and thumbnail generation processing for the plurality of image data items (FIG. 9 through FIG. 12). As a result, the portable terminal can acquire the cluster information database 152 and thumbnail files obtained from the plurality of image data items. Accordingly, the portable terminal can, for example, display a list of the clusters.

That is, by connecting the server apparatus including the image processing apparatus 100 to the Internet, it is possible to provide a service such as cluster generation processing or thumbnail generation processing for a plurality of portable terminals.

Moreover, for example, it is acceptable if the portable terminal including the image processing apparatus 100 is connected to the Internet and a plurality of the image data items stored on the recording medium 101 are acquired from the server apparatus including the recording medium 101. That is, using a portable terminal at hand, it is possible for a user to execute the generation of the cluster information database 152 or thumbnail files, for example, for a plurality of image data items stored in the recording medium 101 over the Internet.

Furthermore, it is acceptable to access the server apparatus including the recording medium 101 and the image processing apparatus 100 via the Internet from a portable terminal including the input device 108 and the display device 109, and cause the server apparatus to execute the cluster generation processing and the thumbnail generation processing, for example.

Moreover, the image processing apparatus 100 included in a server apparatus, for example, may batch process a plurality of image data items stored in a portable terminal and a plurality of image data items stored on the Internet in a different server apparatus.

Moreover, the recording medium 101 may be part of the image processing apparatus 100 internally. For example, when the image processing apparatus 100 includes an internal hard disk drive (HDD), the recording medium 101 may be realized as an HDD. Moreover, for example, the recording medium 101 may be realized as a portable medium such as a SD card which is detachable from the image processing apparatus 100.

Moreover, in this embodiment, various processes were explained for when an object that is a candidate for detection by the image processing apparatus 100 is a face (or facial region) depicted in the image data.

However, an object that is a candidate for detection by the image processing apparatus 100 may be something other than a person's face, and may be a whole physical object or a part of a physical object other than a person (for example, a physical object such as an animal, plant, vehicle, or building).

In this case, it is possible for the object detecting unit 103 to recognize physical objects using a physical object detection technique. Since the essence of the present invention does not relate to physical object detection techniques, details thereof will be omitted. However, it goes without saying that any general method of physical object detection can be used.

Moreover, the processing sequences shown in each flowchart are not limited to the sequences shown in particular, and it goes without saying that the sequence of the steps may be rearranged as long as the same end result is achieved.

Moreover, according to this embodiment, the “image” that is a candidate for processing by the image processing apparatus 100 is not limited to a still image, but also includes video. In this case, since the essence of the present invention does not relate to methods of face detection for people or methods of physical object detection in video, details thereof will be omitted. However, any method may be used as long as a facial region of a person photographed in a video can be extracted or a physical object region photographed in a video can be extracted.

Moreover, in this embodiment, the classification result for the facial region is stored in the cluster information database 152 such that the cluster and the facial region are directly linked, as is shown in FIG. 8.

However, the cluster information database 152 may have a hierarchical structure different from the hierarchical structure shown in FIG. 8.

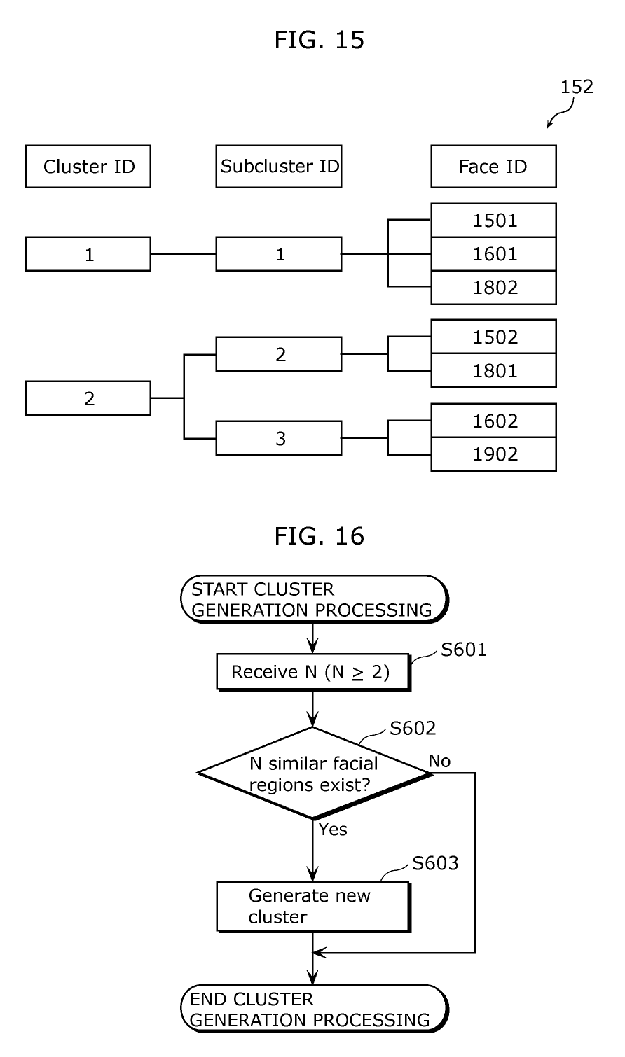

FIG. 15 is an example of the cluster information database 152 according to this embodiment which has a different data structure.

For example, as is shown in FIG. 15, the cluster information database 152 may have a hierarchical structure in which facial regions having even more similar characteristic values are registered in a subcluster, and facial regions having similar characteristic values are registered across subclusters.

With this structure, one face thumbnail included in the subcluster can be displayed when, for example, a list of the subclusters is displayed. Also, by assigning a person's name on a subcluster basis, it is possible to more accurately assign peoples names.

Moreover, in this embodiment, two facial regions having similar characteristic values are registered in a cluster. That is, as a condition for the generation of the cluster information, the number of objects having characteristic values which are closely related (similar objects) is 2.

However, as a condition for the generation of the cluster information, the number of similar objects is not limited to two; it is acceptable for cluster information to be generated when more than two facial regions are closely related.

Moreover, for example, as a condition for the generation of cluster information, the number of similar objects N may be treated as a variable number.

FIG. 16 is a flow chart outlining the cluster generation processes when an N number is made to be a variable number as a cluster information generation condition.

For example, when an integer N (N≧2) is input into the input device 108 by a user, the cluster information generating unit 105 receives the input integer N (S601). When an N number of similar facial regions exist (yes in S602), that is, when each of the characteristic values of the N number of facial regions are within a predetermined range, the cluster information generating unit 105 further generates cluster information showing the cluster to which the N number of facial regions belong (S603).

In this way, as a condition for cluster information generation, by treating the number of similar objects as the variable N, a condition for the selection of objects as candidates for thumbnail generation can be made to be stricter by, for example, increasing the value of N.

For example, suppose that multiple images (for example, 1000 or more images) resulting from photographing a predetermined group such as a family are candidates for thumbnail generation processing. In this case, there is a possibility that people unrelated to the group appear in about two or three of the images. Moreover, because there are so many images, it can be assumed that each member of the group will appear in at least 20 or more images.

In this case, for example, by making N=10, the image processing apparatus 100 can exclude the people unrelated to the group from being eligible as a candidate for face thumbnail generation, and select the faces of each member of the group with near certainty as candidates for face thumbnail generation.

Moreover, according to this embodiment, facial regions which do not appear in more than one image data item are not registered in a cluster. That is, when a preexisting, similar facial region does not exist for a facial region which is the current candidate for processing (current facial region), a cluster to which the current facial region belongs is not generated upon this confirmation.

However, even when there is no preexisting facial region which is similar to the current facial region, the image processing apparatus 100 may generate a cluster to which the current facial region belongs depending on a comparison result of the characteristic value of the current facial region and a threshold value.

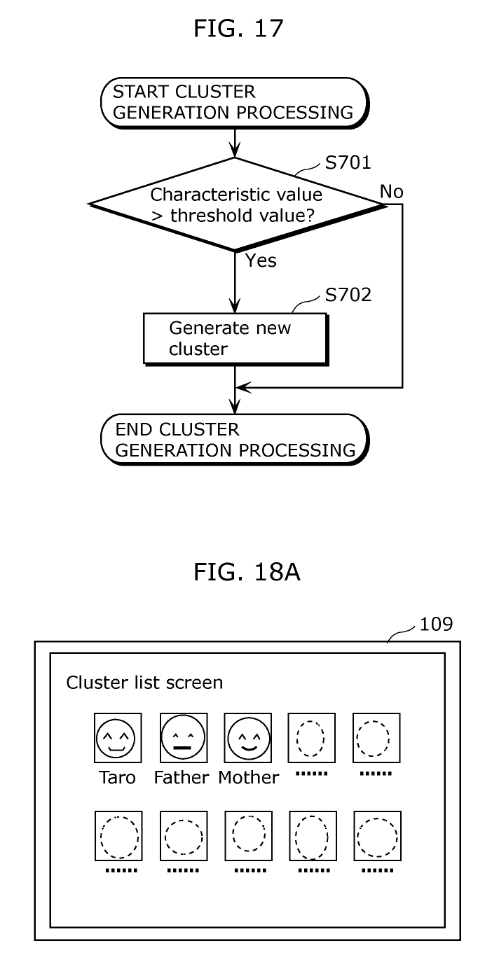

FIG. 17 is a flow chart outlining the cluster generation processes associated with the comparison of a threshold value and the characteristic value of an object which is a candidate for processing.

For example, assume that the ratio of the area of the current facial region to the entire image in which the current facial region appears (one example of a characteristic value of the current facial region) exceeds a threshold value (for example 50%) (yes in S701). In this case, the cluster information generating unit 105 may generate a cluster to which the current facial region belongs regardless of whether or not a similar facial region exists (S702).

With this, for example, even if there is image data for only one image in which a given person is photographed, if the image data shows that the photograph of the person is a close-up photograph, the person is deemed to be of importance to the user, and a face thumbnail is generated. That is, it is possible for the image processing apparatus 100 to execute the processes related to displaying the face thumbnail of a person deemed to be of importance early on.

Moreover, the cluster information generating unit 105 may determine whether to generate a cluster to which the current facial region belongs depending on the degree of blur of the face in the current facial region, for example. Specifically, the cluster information generating unit 105 may generate a cluster to which the current facial region belongs when it is determined, from the characteristic value of the current facial region, that the focal point is focused on the face depicted therein.

Moreover, the image processing apparatus 100 may count a plurality of image data items resulting from images being taken using a consecutive shooting function as one image data item with regard to a plurality of similar facial regions shown throughout the plurality of image data items.

With this, when images are taken using a consecutive shooting function, it becomes possible to prevent the erroneous generation of face thumbnails for a person of unimportance consecutively captured in the background of a plurality of pictures.

It is to be noted that it is possible to identify whether pictures are taken with the consecutive shooting function by, for example, determining that pictures taken within extremely short intervals of each other, as indicated in the exposure date and time information accompanying the image data, are pictures that were taken with the consecutive shooting function. Moreover, when the consecutive shooting function in a camera is used to photograph images, it is acceptable to check information indicating such assigned to the image data by the camera.

While in this embodiment the image processing apparatus 100 generated face thumbnails for all of the facial regions belonging to each cluster, generation is not limited to this. For example, similar to the facial regions belonging to a subcluster as previously described, thumbnails may be generated only for two or more facial regions selected from the same cluster whose characteristic values are extremely similar.

For example, assume that out of 10 facial regions belonging to a given cluster, three facial regions having characteristic values densely distributed within the space of the characteristic values. In this case, the selecting unit 106 selects these three facial regions, and the thumbnail generating unit 107 generates thumbnails for the three facial regions.

As a result, when a large number of facial regions are registered in a single cluster, before generating face thumbnails for all of the facial regions, it is possible to generate face thumbnails for only a portion of the facial regions and display a list of the cluster using these face thumbnails, for example.

Moreover, the image processing apparatus 100 may select only the facial regions within a cluster having average characteristic values and generate the face thumbnail data. That is, the selecting unit 106 may select, from among three or more facial regions shown in a given piece of cluster information, the facial regions having characteristic values that are closest to the average value of the three or more facial regions as candidates for thumbnail generation. This yields the same effect as the previously described case.

Moreover, the image processing apparatus 100 may select facial regions having characteristic values that are far from the average value of the characteristic values within a cluster and generate face thumbnail data. That is, the selecting unit 106 may select, from among three or more facial regions shown in a given piece of cluster information, as a candidate or candidates for thumbnail generation, (i) the facial region having a characteristic value that is different from the average value of the three or more facial regions by a value is the greatest, or (ii) the facial regions having characteristic values that are different from the average value of the three or more facial regions by values that are greater than or equal to a predetermined value.

In this case, for example, facial regions which, in essence, should not be in the cluster are selected, and thumbnails are generated for the facial regions. As a result, the user can delete the facial regions from the cluster at a relatively early stage. Moreover, the user can delete generated thumbnails which are not essentially needed at a relatively early stage.

For example, assume that a cluster is generated which includes a facial region for a person A and a facial region for a person B as a result of their faces being similar. In other words, consider a situation in which a mistake arises when the cluster is generated. Even in this situation, it is possible to correct the mistake at an early stage, and wasteful use of space in the recording medium 101 can be limited.

It is to be noted that when a facial region is deleted from the cluster, the cluster information generating unit 105 updates the cluster information database 152 such that the facial region is deleted from the cluster as per a predetermined instruction made by the user in the input device 108, for example.

Moreover, when a generated thumbnail is deleted, the thumbnail generating unit 107 selects and deletes the thumbnail from the recording medium 101, as per a predetermined instruction made by the user in the input device 108, for example.

Moreover, when the thumbnail generating unit 107 deletes a given thumbnail, other thumbnails having a characteristic value similar to the characteristic value (that is, the difference of the characteristic values is smaller than a predetermined value) of the given thumbnail may also be deleted from the recording medium 101. It is to be noted that the “other thumbnails” are identified via the selecting unit 106 checking the characteristic values calculated by the characteristic value calculation unit 104 for each face ID.

In this case, the cluster information generating unit 105 deletes the facial regions corresponding to the other thumbnails from the cluster information in which the facial regions are registered.

As a result, for example, when a plurality of facial regions for person B belong to the cluster corresponding to person A, the plurality of facial regions for person B can be deleted in one batch.

That is, when thumbnails deemed to be of unimportance to the user are deleted, space on the recording medium 101 can be used more effectively by deleting other thumbnails also estimated to be of unimportance.

Moreover, in this case, it is admissible to confirm with the user whether it is acceptable to delete the other thumbnails, and delete the thumbnail files only when confirmed by the user.

Moreover, when the thumbnails are deleted, the cluster information indicating the cluster to which the thumbnails correspond may be deleted from the cluster information database 152 after confirmation by the user, for example. Moreover, in this case, it is acceptable to make the cluster information appear to be deleted to the user without actually permanently deleting the cluster information.

For example, when the cluster information is not deleted, a deletion flag is added to the cluster information which indicates that an instruction of deletion was received for the cluster information.

In this case, the foregoing processes are acceptable. In other words, a deletion flag is added to cluster information at a point in time when the cluster information corresponding to a person C determined to be of unimportance by the user.

In this case, all thumbnails corresponding to that piece of cluster information are deleted from the recording medium 101, for example. Moreover, as a result of the deletion flag being added, the cluster information is no long eligible as a candidate for selection by the selecting unit 106.

In other words, the objects indicated in the cluster information are not eligible as candidates for thumbnail generation by the thumbnail generating unit 107.

However, consider a situation in which afterwards, a facial region for the person C is selected with respect to image data in which the person C is depicted, as per a predetermined operation made by the user in the input device 108, for example. At this point in time, the cluster information including the facial region ID is flagged with a deletion flag but still exists in the cluster information database 152.

In this situation, the cluster information generating unit 105 removes the deletion flag from the cluster information. As a result, the cluster information becomes eligible as a candidate for selection by the selecting unit 106. With this, the thumbnail generating unit 107 can generate a thumbnail of the facial region for the person C selected by the user as well as a thumbnail for other facial regions indicated in the cluster information.

With this, for example, even when a cluster corresponding with a given thumbnail appears to be deleted after deleting the given thumbnail, by restoring the thumbnail, all other thumbnails belonging to that cluster can be restored.

Moreover, the selecting unit 106 may select facial regions as candidates for thumbnail generation from only those clusters which meet a predetermined condition.

For example, the selecting unit 106 identifies those clusters to which a predetermined number of facial regions or more are registered (for example, 10 or more), and selects one or more facial regions that belong to the identified clusters. It is to be noted that the predetermined number may be a variable number, and may be a number determined by the user, for example.

With this, for example, even when cluster information is generated which corresponds to an unrelated person as a result of the unrelated person appearing in a plurality of images, the unrelated person can be excluded from eligibility as a candidate for face thumbnail generation.

In other words, the same effect is achieved as when the variable N is used as a condition for cluster information generation, which was explained with reference to FIG. 16.

As described above, the image processing apparatus 100 according to this embodiment selects one or more facial regions based on the characteristic values of a plurality of facial regions acquired from a plurality of images, and registers only the selected facial regions in a cluster. Moreover, thumbnails are only generated for the facial regions registered in the cluster.

As a result, it is possible to exclude facial regions for which thumbnail generation is not necessary from being eligible as a candidate for thumbnail generation and display various types of displays such as a list of the clusters and a list of the thumbnails.

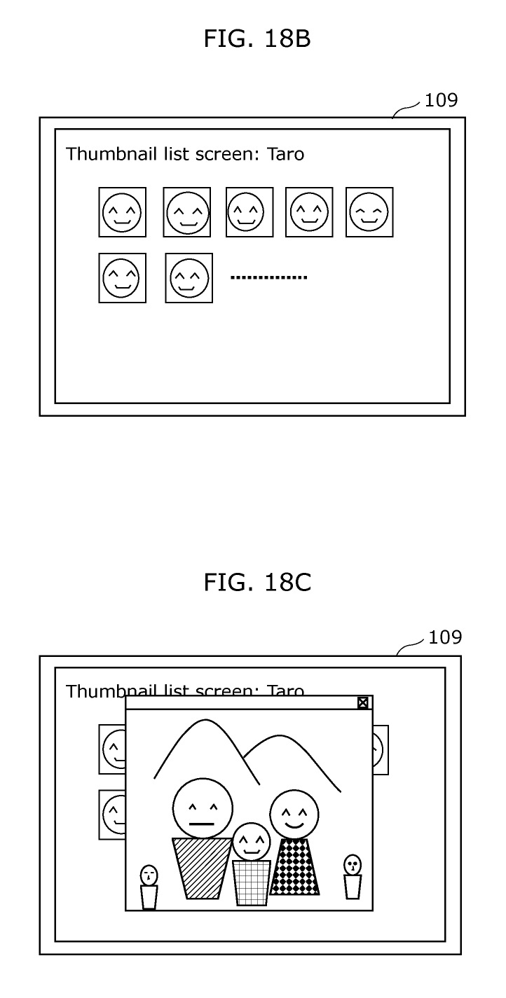

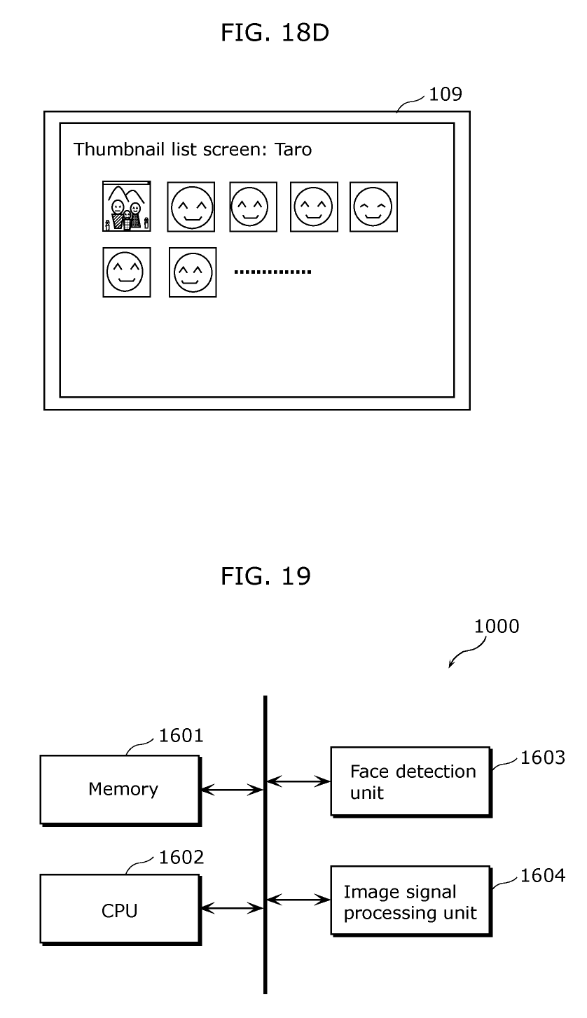

FIG. 18A is an example of a cluster list output from the image processing apparatus 100 according to this embodiment.

FIG. 18B is an example of a thumbnail list output from the image processing apparatus 100 according to this embodiment.

A cluster list such as the one shown in FIG. 18A, for example, is displayed on the display device 109 as a result of the image processing apparatus 100 detecting and classifying a facial region and performing cluster generation as described above.

The cluster list shown in FIG. 18A corresponds to the information within the cluster information database 152 shown in FIG. 8. In the cluster list, a representative thumbnail for each cluster is shown.

Moreover, a name is attributed to each cluster. Specifically, the name “Taro” is attributed to the cluster with an ID of 1, the name “Father” is attributed to the cluster with an ID of 2, and the name “Mother is attributed to the cluster with an ID of 3.

It is to be noted that the names are attributed, for example, in accordance with an instruction input into the input device 108 by a user. Moreover, for example, the name of each cluster may be attributed automatically by matching an average value of the characteristic values in each cluster with a database for a person.

When the thumbnail labeled “Taro” in this cluster list is clicked, the information displayed on the display device 109 switches to the thumbnail list shown in FIG. 18B, for example.

The thumbnails displayed in the thumbnail list shown in FIG. 18B are those for a plurality of facial regions belonging to the cluster “Taro” which has a cluster ID of 1.

By browsing this thumbnail list, a user can confirm whether a not a face of a person other than Taro has been added to the cluster as a result of an erroneous recognition due to a lack of brightness in the facial region, for example. In such a case where a person other than Taro has been added to the cluster labeled “Taro”, the user can give a predetermined instruction to the image processing apparatus 100 to update the cluster information database 152 such that the facial region corresponding to the face of the other person to belong to an appropriate cluster, or to belong to none of the clusters.

Furthermore, by clicking any one of the thumbnails in the thumbnail list, a user can check the full image in which the facial region shown in the thumbnail is included.

FIG. 18C is an example showing a manner in which a selected image is displayed as output from the image processing apparatus 100 according to an aspect of the present invention, and FIG. 18D is another example showing a manner in which a selected image is displayed.

When any one of the thumbnails in the thumbnail list shown in FIG. 18B is clicked, the full image in which the facial region shown in the clicked thumbnail is included is displayed on top of the thumbnail image, as is shown in FIG. 18C.

Similarly, when any one of the thumbnails is clicked, a thumbnail of the full image in which the facial region is included is displayed in place of the thumbnail, as is shown in FIG. 18D.

In either case shown in FIG. 18C and FIG. 18D, the user can visually check the full image which corresponds with the face selected from the list of thumbnails.

The preceding descriptions of the image processing apparatus according to the present invention are based on this embodiment. However, the present invention is not limited to this embodiment. Various modifications of the exemplary embodiments as well as embodiments resulting from arbitrary combinations of constituent elements of the different exemplary embodiments that may be conceived by those skilled in the art are intended to be included within the scope of the present invention as long as these do not depart from the essence of the present invention.

For instance, the following cases are also included within the scope of the present invention.

(1) The preceding image processing apparatus 100 is a computer system configured of, specifically, a microprocessor, ROM (Read Only Memory), RAM (Random Access Memory), a hard disk unit, a display unit, a keyboard, and a mouse, for instance. A computer program is stored in the RAM or the hard disk unit. The image processing apparatus 100 achieves its function as a result of the microprocessor operating according to the computer program. Here, the computer program is configured of a plurality of pieced together instruction codes indicating a command to the computer in order to achieve a given function. It is to be noted that the image processing apparatus 100 is not limited to a computer system including, for example, each of a microprocessor, ROM, RAM, a hard disk unit, a display unit, a keyboard, and a mouse, and may be configured as a computer system including a portion of these components.

(2) A portion or all of the components of the image processing apparatus 100 may be configured from one system LSI (Large Scale Integration). A system LSI is a super-multifunction LSI manufactured with a plurality of components integrated on a single chip, and is specifically a computer system configured of a microprocessor, ROM, and RAM, for example. A computer program is stored in the RAM. The system LSI achieves its function as a result of the microprocessor operating according to the computer program.

Moreover, each unit of the components constituting the image processing apparatus 100 may be individually configured into single chips, or a portion or all of the units may be configured into a single chip.

Moreover, here the process is called a system LSI, but depending on the level of integration, the processes are also known as IC, LSI, super LSI, or ultra LSI. Moreover, the method of creating integrated circuits is not limited to LSI, but an integrate circuit may be realized as a specialized circuit or a general purpose processor. An FPGA (Field Programmable Gate Array) which allows post-manufacturing programming or a reconfigurable processor in which the connections and settings of a circuit cell in the LSI are reconfigurable may also be used.

Furthermore, if an integrated circuit technology comes about replacing LSI with the advancement in semiconductor technology or the launching of other technologies, of course that technology may also be used for integrating function blocks. As a potential application, biotechnology is also a possibility.

(3) A portion or all of the components of the image processing apparatus 100 may each be configured from a detachable IC card or a stand-alone module. The IC card and the module are computer systems configured from a microprocessor, ROM, and RAM, for example. The IC card and the module may include the super-multifunction LSI described above. The IC card and the module achieve their function as a result of the microprocessor operating according to a computer program. The IC card and the module may be tamperproof.

(4) the present invention may be a method including the processing executed by the image processing apparatus 100 described above. Moreover, the present invention may also be a computer program realizing this method with a computer, or a digital signal of the computer program.

Moreover, the present invention may also be realized as the computer program or the digital signal stored on recording medium readable by a computer, such as a flexible disk, hard disk, CD-ROM (Compact Disc), MO (Magneto-Optical disk), DVD (Digital Versatile Disc), DVD-ROM, DVD-RAM, DVD-RAM, BD (Blu-ray Disc), or a semiconductor memory. The present invention may also be the digital signal stored on the above mentioned recording medium.

Moreover, the present invention may also be realized by transmitting the computer program or the digital signal, for example, via an electric communication line, a wireless or wired line, a network such as the Internet, or data broadcasting.

Moreover, the present invention may be a computer system including memory storing the computer program and a microprocessor operating according to the computer program.

Moreover, the computer program or the digital signal may be implemented by an independent computer system by being stored on the recording medium and transmitted, or sent via the network.

(5) The preceding embodiments and the preceding transformation examples may be individually combined.

### INDUSTRIAL APPLICABILITY

The image processing apparatus and the image processing method according to the present invention can be applied as a device having the ability to classify image data by objects shown in the image data and manage the data, as well applied as a image processing method for executing the device, for example. The image processing apparatus and the image processing method according to the present invention is also applicable for use in image processing software, for example.

### REFERENCE SIGNS LIST

100 image processing apparatus
101 recording medium
102 acquisition unit
103 object detecting unit
104 characteristic value calculation unit
105 cluster information generating unit
106 selecting unit
107 thumbnail generating unit
108 input device
109 display device
151 detection result database
152 cluster information database
153 image management database

1. An image processing apparatus comprising:
an acquisition unit configured to acquire a plurality of image data items;
an object detecting unit configured to detect a plurality of objects from the image data items acquired by the acquisition unit, each of the objects being indicated in at least one of the image data items;
a characteristic value calculation unit configured to calculate a characteristic value of each of the objects detected by the object detecting unit;
a cluster information generating unit configured to, when the characteristic value of at least one of the objects meets a predetermined condition, generate first cluster information indicating a first cluster which is associated with the characteristic value of the at least one object and to which the at least one object belongs;
a selecting unit configured to select an object for which a thumbnail is to be generated from among the at least one object indicated in the first cluster information generated by the cluster information generating unit; and
a thumbnail generating unit configured to generate the thumbnail of the object using one of the image data items that indicates the object selected by the selecting unit.

2. The image processing apparatus according to claim 1,
wherein when the characteristic value of each of two or more of the objects including the at least one object meets the predetermined condition, the cluster information generating unit is configured to generate the first cluster information indicating the first cluster to which the two or more objects belong, the predetermined condition being that the characteristic value of each of the two or more objects is within a predetermined range.

3. The image processing apparatus according to claim 2,
wherein when an input of an integer N greater than or equal to two is received and N objects including the at least one object each has a characteristic value calculated by the characteristic value calculation unit that is within the predetermined range, the cluster information generating unit is configured to generate the first cluster information indicating the first cluster to which the N objects belong.

4. The image processing apparatus according to claim 1,
wherein when the characteristic value of the at least one object meets the predetermined condition, the cluster information generating unit is configured to generate the first cluster information indicating the first cluster to which the at least one object belongs, the predetermined condition being that the characteristic value exceeds a threshold value.

5. The image processing apparatus according to claim 1,
wherein when a characteristic value calculated by the characteristic value calculation unit of one of the objects other than the at least one object meets the predetermined condition, the cluster information generating unit is configured to update the generated first cluster information to include the other object in the first cluster.

6. The image processing apparatus according to claim 5,
wherein the selecting unit is configured to select all of the objects indicated in the first cluster information as objects for which thumbnails are to be generated, and
the thumbnail generating unit is configured to generate thumbnails of all the objects selected by the selecting unit, using the respective image data items indicating all the objects.

7. The image processing apparatus according to claim 1,
wherein when a characteristic value calculated by the characteristic value calculation unit of one of the objects other than the at least one object (i) does not meet the predetermined condition and (ii) the characteristic value of the other object and the characteristic value of a preexisting one of the objects which does not meet the predetermined condition are within a predetermined range, the cluster information generating unit is further configured to generate second cluster information indicating a second cluster to which the other object and the preexisting object belong, and
the selecting unit is further configured to select, from at least one of the first cluster information and the second cluster information, an object for which a thumbnail is to be generated.

8. The image processing apparatus according to claim 7,
wherein the selecting unit is further configured to select, from among each of the first cluster information and the second cluster information, an object for which a thumbnail is to be generated.

9. The image processing apparatus according to claim 1,
wherein the selecting unit is configured to select, from among three or more of the objects indicated in the first cluster information and including the at least one object, an object for which a thumbnail is to be generated having the characteristic value that is closest to an average value of characteristic values of the three or more objects.

10. The image processing apparatus according to claim 9,
wherein the selecting unit is further configured to select, from among the three or more of the objects indicated in the first cluster information and including the at least one object, an object for which a thumbnail is to be generated having the characteristic value that is different from the average value of characteristic values of the three or more objects by a value that is greater than or equal to a predetermined value or a value that is greatest.

11. The image processing apparatus according to claim 1,
wherein the thumbnail generating unit is configured to (i) record the generated thumbnail on a recording medium connected to the image processing apparatus, and (ii) when the generated thumbnail is deleted from the recording medium as per a predetermined instruction made by a user, delete an other thumbnail stored on the recording medium corresponding to one of the objects having the characteristic value that is different from the characteristic value of the deleted thumbnail by a value that is less than a predetermined value.

12. The image processing apparatus according to claim 11,
wherein when the thumbnail deleted from the recording medium is to be generated once again, the thumbnail generating unit is further configured to once again generate the other thumbnail deleted along with the thumbnail.

13. The image processing apparatus according to claim 1,
wherein each of the objects is, in whole or in part, a face of a person or a physical object other than a person.

14. An image processing method comprising:
acquiring a plurality of image data items;
detecting a plurality of objects from the image data items acquired in the acquiring, each of the objects being indicated in at least one of the image data items;
calculating a characteristic value of each of the objects detected in the detecting;
when the characteristic value of at least one of the objects meets a predetermined condition, generating first cluster information indicating a first cluster which is associated with the characteristic value of the at least one object and to which the at least one object belongs;
selecting an object for which a thumbnail is to be generated from among the at least one object indicated in the first cluster information generated in the generating of first cluster information; and
generating the thumbnail of the object using one of the image data items that indicates the object selected in the selecting.

15. An integrated circuit comprising:
an acquisition unit configured to acquire a plurality of image data items;
an object detecting unit configured to detect a plurality of objects from the image data items acquired by the acquisition unit, each of the objects being indicated in at least one of the image data items;
a characteristic value calculation unit configured to calculate a characteristic value of each of the objects detected by the object detecting unit;
a cluster information generating unit configured to, when the characteristic value of at least one of the objects meets a predetermined condition, generate first cluster information indicating a first cluster which is associated with the characteristic value of the at least one object and to which the at least one object belongs;
a selecting unit configured to select an object for which a thumbnail is to be generated from among the at least one object indicated in the first cluster information generated by the cluster information generating unit; and
a thumbnail generating unit configured to generate the thumbnail of the object using one of the image data items that indicates the object selected by the selecting unit.

16. A program recorded on a non-transitory computer-readable recording a medium, the program causing a computer to execute:
acquiring a plurality of image data items;
detecting a plurality of objects from the image data items acquired in the acquiring, each of the objects being indicated in at least one of the image data items;
calculating a characteristic value of each of the objects detected in the detecting;
when the characteristic value of at least one of the objects meets a predetermined condition, generating first cluster information indicating a first cluster which is associated with the characteristic value of the at least one object and to which the at least one object belongs;
selecting an object for which a thumbnail is to be generated from among the at least one object indicated in the first cluster information generated in the generating of first cluster information; and
generating the thumbnail of the object using one of the image data items that indicates the object selected in the selecting.
